(19) United States
(12) Patent Application Publication
(10) Pub. No.: US 2001/0006999 A1
(43) Pub. Date: Jul. 5, 2001

(54) Rubber composition and fuel system hose

(75) Inventors: Tsuyoshi Konno, Kawasaki-shi (JP); Toshiaki Saya, Kawasaki-shi (JP); Atsushi Suzuki, Aichi-ken (JP); Hideyuki Fujiwara, Aichi-ken (JP); Daisuke Tsutsumi, Aichi-ken (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Zeon Corporation, Tokyo (JP)

(21) Appl. No.: 09/739,791

(22) Filed: Dec. 20, 2000

(30) Foreign Application Priority Data
Dec. 22, 1999 (JP) 11-364484

(51) Int. Cl. C08L 27/06; C08L 35/04; C08L 33/18

(52) U.S. Cl. 525/238; 525/239

(57) ABSTRACT

A rubber composition comprising a nitrile rubber (a) having a bound unsaturated nitrile content of 43-60% by weight and a polymer Mooney viscosity (ML₁₊₄, 100°) of 95-140 and a vinyl chloride resin (b).

When an unvulcanized rubber hose is formed by using the rubber composition of the present invention and the unvulcanized hose is vulcanized with a mandrel being inserted thereinto, the hose does not develop cracks at all. Moreover, the fuel system obtained from the rubber composition of the present invention is also excellent in resistance to fuel permeation and in resistance to low temperature.

### BACKGROUND OF THE INVENTION

The present invention relates to a rubber composition which does not develop cracks in the production of fuel system hoses therefrom and to a fuel system hose excellent in resistance to fuel permeation which comprises the vulcanized product of the composition.

With environmental problems assuming increasing more serious aspects, the improvement of the performances of fuel system hoses used for fuel piping of automobiles and the like has been greatly required to reduce the evaporation of fuel oils, such as gasoline, into the air.

Previously, as the material for fuel system hoses, there has been used medium high nitrile rubber (acrylonitrile-butadiene copolymer rubber, hereinafter referred to as “NBR”) having a bound acrylonitrile content of about 33.5% by weight or a blend comprising high NBR having a bound acrylonitrile content of about 41% by weight and poly(vinylchloride) (PVC) (the blend of NBR and PVC being hereinafter sometimes referred to as “polyblend”), both as a material well balanced among ozone resistance, gasoline swelling resistance and low temperature resistance.

However, fuel system hoses produced from the above-mentioned material alone are rather highly permeable to gasoline, and hence previous fuel system hoses can hardly meet the requirement of further reducing the amount of gasoline evaporating into the air.

For improving the resistance to fuel permeation of fuel system hoses, it has been proposed to use a blend of ultra-high NBR (having a bound acrylonitrile content of 43% by weight or more) with poly(vinyl chloride) (JP-A-4-171381).

However, when a hose comprising a polyblend of common ultra-high NBR and poly(vinyl chloride) is produced by extruding such a polyblend into the form of a hose, inserting a mandrel thereinto, and vulcanizing by using a vulcanizer, the resulting hose is apt to develop cracks at its end face and bend.

### SUMMARY OF THE INVENTION

The object of the present invention is to provide a rubber composition which can be used for producing a fuel system hose excellent in resistance to fuel permeation and resistance to low temperature without development of cracks even when a mandrel is inserted into an unvulcanized suffer hose and the hose is vulcanization-formed.

The present inventors have made extensive study to attain the above-mentioned object. As a result, it has been found out that a fuel system hose excellent in resistance to fuel permeation and resistance to low temperature can be produced, without development of cracks even when a mandrel is inserted into an unvulcanized rubber hose and the hose is vulcanized, by using as the ultra-high nitrile rubber a ultra-high nitrile rubber which has a higher polymer Mooney viscosity than common ultra-high nitrile rubbers hitherto used having a Mooney viscosity (ML₁₊₄, 100° C.) of about 45-90. The present invention has been accomplished on the basis of above finding.

Thus, according to the present invention, there are provided a rubber composition comprising a nitrile rubber (a) having a bound unsaturated nitrile content of 43-60% by weight and a polymer Mooney viscosity (ML₁₊₄, 100° C.) of 95-140 and a vinyl chloride resin (b), and a fuel system hose comprising the vulcanized product of the composition.

### DETAILED DESCRIPTION OF THE INVENTION

Some embodiments of the present invention are described in detail below.

The nitrile rubber used in the present invention is a rubber obtained by copolymerizing an α,β-ethylenically unsaturated nitrile monomer with a conjugated diene monomer.

Specific examples of the α,β-ethylenically unsaturated nitrile monomer include vinyl cyanides, such as acrylonitrile, methacrylonitrile and α-chloroacrylonitrile.

Specific examples of the conjugated diene monomers include 2-methyl-1,3-butadiene, 1,3-butadiene, 1,3-pentadiene, isoprene and 2-chloro-1,3-butadiene. These monomers may be used each alone or in a combination of two or more thereof.

Besides the above-mentioned monomers, if desired and within a range not deleterious to the effect of the present invention, other monomers copolymerizable therewith may be used in place of a part of the conjugated diene monomer. The copolymerizable other monomers are not particularly limited and may be, for example, aromatic vinyl monomers, such as styrene, α-methylstyrene and vinylpyridine; nonconjugated diene monomers, such as vinylnorbornene, dicyclopentadiene and 1,4-hexadiene; α,β-ethylenically unsaturated carboxylic acids, such as acrylic acid, methacrylic acid, maleic acid and maleic anhydride; alkyl acrylates and alkyl methacrylates, (which may have a substituent, such as a hydroxyl group, cyano group and alkoxyl group having 1-5 carbon atoms) wherein the alkyl group has 1-10 carbon atoms; and α,β-ethylenically unsaturated dicarboxylic acid ester monomers, such as monoalkyl esters of α,β-ethylenically unsaturated dicarboxylic acids wherein the alkyl group has 1-10 carbon atoms and dialkyl esters of α,β-ethylenically unsaturated dicarboxylic acids wherein the alkyl group has 1-10 carbon atoms. These monomers may be used each alone or in a combination of two or more thereof. The content of these copolymerizable monomers in the copolymer is not more than 15% by weight, preferably not more than 10% by weight, more preferably not more than 5% by weight. A higher content than mentioned above may adversely affect the resistance to low temperature and the resistance to fuel permeation of the hose. A particularly preferred nitrile rubber in the present invention is a copolymer rubber of acrylonitrile with butadiene (NBR).

The nitrile rubber used in the present invention is usually produced by radical-copolymerizing the above-mentioned monomers. The methods of polymerization is not particularly limited, and any method of polymerization known previously, e.g., emulsion polymerization, suspension polymerization and solution polymerization, may be used, particularly preferred being emulsion polymerization.

The emulsion polymerization is usually a process wherein a monomer, organic solvent, polymerization initiator, emulsifier, chain transfer agent, etc. are added to an aqueous medium (usually water) and the monomer is polymerized. The process may be any of the batch wise one, semi-batch wise one and continuous one. The emulsifier used may be previously known ones and is not particularly limited. The examples thereof include anionic surfactants (e.g., higher alcohol sulfuric ester salts, alkylbenzene-sulfonic acid salts and aliphatic carboxylic acid ester sulfonic acid salts), nonionic ones (e.g., polyethylene glycol alkyl ester type, alkylphenyl ether type and alkyl ether type) and amphoteric ones (comprising, as the anionic moiety, carboxylic acid salts, sulfuric ester salts, sulfonic acid salts, phosphoric acid salts or phosphoric ester salts, and, as the cationic moiety, amine salts or quaternary ammonium salts). The polymerization initiator also may be any of the radical polymerization initiators known to the art and is not particularly limited. It may be, for example, redox type catalysts comprising a combination of a reducing agent, such as ferrous salts and tetraethylene-pentamine, with an inorganic peroxide, such as hydrogen peroxide and potassium persulfate, or with an organic peroxide, such as cumene hydroperoxide, diisopropylbenzene hydroperoxide and paramenthane hydroperoxide. The polymerization temperature also is not particularly limited; polymerization may be ordinarily carried out over the range of 0° to 50° C.

The nitrile rubber used in the present invention has a bound unsaturated nitrile monomer content in the rubber in the range of 43-60% by weight, preferably 44-55% by weight, more preferably 44-52% by weight. When the content is higher than the above-mentioned range, the hose obtained is poor in resistance to low temperature; when it is lower than the range, the hose has insufficient resistance to fuel permeation.

The polymer Mooney viscosity (ML₁₊₄, 100° C.; determined according to JIS K6300) of the nitrile rubber characterizing the present invention is in the range of 95-140, preferably 95-130, more preferably 95-120. When the viscosity is lower than the above-mentioned range, cracks may develop when a mandrel is inserted into the hose and the hose is vulcanization-formed; when it is higher than the range, the viscosity of the rubber composition becomes too high to make the forming processing difficult.

The vinyl chloride resin used in the present invention may be, for example, vinyl chloride homopolymer (poly(vinylchlorde)) and copolymer resins of vinyl chloride and a monomer copolymerizable therewith.

The copolymerizable monomer is not particularly limited and may be, for example, vinyl esters, such as vinyl acetate, vinyl propionate and vinyl laurate; acrylic acid esters, such as methyl acrylate, ethyl acrylate and butyl acrylate; methacrylic acid esters, such as methyl methacrylate and ethyl methacrylate; fumaric acid esters, such as dibutyl fumarate and diethyl fumarate; vinyl ethers, such as vinylmethyl ether and vinyl octyl ether; α-olefins, such as ethylene, propylene and styrene; vinylidene halides or vinyl halides other than vinyl chloride, such as vinylidene chloride and vinyl bromide; and multifunctional monomers, such as diacryl phthalate and ethylene glycol dimethacryalte. These monomers may be used each alone or in a combiantion of two or more thereof. The content of the copolymerizable monomer in the copolymer is not more than 15% by weight, preferably not more than 10% by weight, more preferably not more than 5% by weight. When the content is higher than the above-mentioned range, the hose obtained by using the copolymer may possibly be poor in resistance to ozone, resistance to fuel permeation and resistance to low temperature. Preferred among the vinyl chloride resins used in the present invention is poly(vinyl chloride).

The vinyl chloride resin may be produced by radical-polymerizing the above-mentioned monomer(s) in a known manner and process of polymerization. For example, suspension polymerization, emulsion polymerization and bulk polymerization may be used. The polymerization may be conducted by using any known process including the batchwise process and the continuous process.

The average degree of polymerization of such vinyl chloride resins is in the range of 550 [specific viscosity; 0.239 (ASTM D-1234-58-T), K-Value; 53.8]-2500 [specific viscosity; 0.61 (ASTM D-1234-58-T), K-Value; 92], preferably 600 [specific viscosity; 0.250 (ASTM D-1234-58-T), K-Value; 55]- 2200 [specific viscosity; 0.59 (ASTM D-1234-58-T), K-Value; 87], more preferably 650 [specific viscosity; 0.264 (ASTM D-1234-58-T), K-Value; 56.3]- 2000 [specific viscosity; 0.55 (ASTM-D-1234-58-T), K-Value; 83.2]. When it is smaller than the above-mentioned range, the ozone resistance of the nitrile rubber tends to be improved insufficiently; when it is larger than the range, the viscosity of the resulting rubber composition tends to be so high that the processing of the composition becomes difficult.

The rubber composition of the present invention is produced by mixing and kneading a nitrile as rubber and a vinyl chloride resin. Though the nitrile rubber and the vinyl chloride resin may be mixed in the course of mixing a vulcanizing agent and other compounding ingredients, usually they are used in the form of a polyblend prepared by mixing the nitrile rubber and the vinyl chloride resin beforehand. Mixing of a vinyl chloride resin into a nitrile rubber imparts ozone resistance to the nitrile rubber.

Though the method for preparing a polyblend is not particularly limited, the polyblend may be usually prepared by using known methods, which include, for example, a dry blending method wherein a nitrile rubber and a vinyl chloride resin are blended at a high temperature with a kneading machine, such as a Bambury mixer, kneader and internal mixer, or a latex coprecipitation method wherein the two component resins are mixed in the form of latex, then coagulated (coprecipitated) and dried, and thereafter heat-treated by using an extruder or a kneading machine, such as a Banbury mixer, kneader and internal mixer.

The mixng ratio of the nitrile rubber and the vinyl chloride resin in producing the polyblend or the rubber composition is in the range of 95-50% by weight of the nitrile rubber and 5-50% by weight of the vinyl chloride resin, preferably in the range of 90-55% by weight and 10-45% by weight, respectively, and more preferably in the range of 85-60% by weight and 15-40% by weight, respectively. When the ratio of the vinyl chloride resin is higher than the above-mentioned range, the heat resistance tends to decrease and the compression set tends to increase; when it is lower than the range, the resistance to ozone and the resistance to fuel permeation may possibly deteriorate.

In producing rubber goods by using the rubber composition of the present invention, a vulcanizing agent is compounded into the rubber composition. The vulcanizing agent used in the present invention may be both a sulfur-containing vulcanizing agent and an organic peroxide vulcanizing agent respectively known to the art, and is not particularly limited.

The sulfur-containing vulcanizing agent may be, for example, sulfur and sulfur donative compounds (such as thiuram type compounds and morpholine type compounds). The sulfur-containing vulcanizing agent may be used together with a known vulcanization auxiliary, such as zinc white and stearic acid, and a known vulcanization accelerator of various kinds (such as thiuram type, guanidine type, sulfenamide type, thiazole type and dithiocarbamic acid type).

The amounts of the sulfur-containing vulcanizing agent and the vulcanization accelerator used in the present invention are not particularly limited. However, the sulfur-containing vulcanizing agent and the vulcanization accelerator are used, relative to 100 parts by weight of a polyblend comprising a nitrile rubber and a vinyl chloride resin, respectively in an amount of 0.01-10 parts by weight and 1-20 parts by weight, preferably 0.05-8 parts by weight and 2-15 parts by weight, more preferably 0.1-5 parts by weight and 2-10 parts by weight. When the amount(s) is(are) outside the above-mentioned range, the vulcanization speed tends to be too high or too low, making the rubber processing difficult.

The organic peroxide vulcanizing agent used is an organic peroxide or a combination thereof with a vulcanization auxiliary. The “organic peroxide” refers to an organic compound having an (—O—O—) structure in the molecule and is, for example, dicumyl peroxide, di-t-butyl peroxide, t-butylcumyl peroxide, benzoyl peroxide, 2,4-dichlorobenzyl peroxide, 2,5-dimethyl-2,5-di-(t-butylperoxy)hexyne-3,2,5-dimethyl-2,5-(di(t-butylperoxy)hexane, 1,1-di(t-butylperoxy)-3,3,5-trimethylcyclohexane, t-butylperoxybenzoate, and 1,3-di(t-butylperoxyisopropyl)benzene.

The vulcanization auxiliary used in combination with an organic peroxide is a compound having a multiple unsaturation bond in the molecule and may be, for example, such multi-functional monomers as triallyl cyanurate, triallyl isocyanurate, trimethylolpropane trimethylacrylate, ethylene dimethacrylate, diallyl phthalate, toluylene bismaleimide, metaphenylene bismaleimide, and divinylbenzene; and a liquid vinylpolybutadiene.

In the present invention, the amounts of the organic peroxide and the vulcanization auxiliary are not particularly limited and may be, per 100 parts by weight of the polyblend, respectively 0.1-10 parts by weight and 0.5-20 parts by weight, preferably 0.2-8 parts by weight and 0.7-10 parts by weight, more preferably 0.3-5 parts by weight and 1-5 parts by weight. When the amount(s) is(are) outside the above-mentioned range, the vulcanization speed tends to be too low or too high, making the rubber processing difficult.

The rubber composition containing the vulcanizing agent of the present invention can be produced by mixing and blending a nitrile rubber, vinyl chloride resin, vulcanizing agent and, according to necessity, one or more other compounding ingredients, for example, reinforcing agents such as carbon black and silica, fillers such as calcium carbonate and clay, softeners, plasticizes (of phthalate type, adipate type, sebacate type, phosphate type, polyether type, polyester type, etc.), antioxidants (of amine type, phenol type, etc.), stabilizers and processing aids, by using a kneading machine, such as a roll, Banbury mixer, kneader, and internal mixer. In the present invention, the kinds and the amounts of the compounding ingredients other than the vulcanizing agent to be used are not particularly limited and can be appropriately selected and determined so as to attain the characteristic properties and other factors required for fuel system hoses and other rubber goods.

The “fuel system hose” obtained by vulcanizing the rubber composition of the present invention refers to hoses used in automobiles, autocycles and the like for filling fuel oils such as gasoline and alcohol-blended gasoline into a fuel tank or transporting them to an engine or the like; specific examples thereof include a fuel hose, fuel inlet hose, fuel breather hose, evaporation hose, and hoses for clearing the ORVR (onboard refueling vapor recovery) regulation.

The fuel system hose of the present invention may be produced by known methods as extrusion and injection, and is not particularly limited as to the method for the production thereof. One example of the method of production comprises first forming a rubber composition containing a vulcanizing agent of the present invention into an unvulcanized rubber hose of a prespecified form by extrusion, then inserting a mandrel (made of a metal, resin or the like) having a predetermined shape into the unvulcanized rubber hose obtained above, and then processing the rubber hose through a steam vulcanization step using a vulcanizer into a fuel system hose of the ultimate product. Though the vulcanization conditions are not particularly limited, the vulcanization is usually performed under conditions of a temperature of 130° C.-170° C. and a pressure of 0.2-7.5 MPa for 15-20 minutes.

As set forth above, according to the present invention, there is provided a rubber composition which develops no cracks when processed in a vulcanizer by using a mandrel and is suitable for producing a fuel system hose excellent in resistance to fuel permeation and resistance to low temperature.

### DESCRIPTION OF PREFERRED EMBODIMENTS

The present invention is described in detail below with reference to Examples and Comparative Examples. Hereinafter, part and % are respectively by weight unless otherwise stated.

### Examples 1-2, Comparative Example 1-3

A plurality of polyblends respectively comprising 70 parts of ultra-high NBRs different in polymer Mooney viscosity (ML₁₊₄, 100° C.) (bound acrylonitrile content 46%, polymer Mooney viscosity 60-110) and 30 parts of poly(vinyl chloride) having an average degree of polymerization of 800 [specific viscosity; 0.31 (ASTM D-1234-58-T), K-Value; 60.6] were prepared by using a hot roll.

According to the compounding formulations shown in Table 1, the polyblends obtained above and various compounding ingredients other than the vulcanizing agent were mixed and kneaded by using a small-sized Banury mixer, then, by using a roll a vulcanizing agent was added to each of the mixtures obtained above and mixed and kneaded to obtain various kinds of vulcanizable rubber compositions.

TABLE 1
Compounding Formulation

| | Comparative | | | | |
|---|---|---|---|---|---|
| Compounding | Example | | | Example | |
| Formulation | 1 | 2 | 3 | 1 | 2 |
| Polyblend | 100 | 100 | 100 | 100 | 100 |
| (Mooney viscosity of | (65) | (80) | (90) | (97) | (110) |
| ultra-high NBR) | | | | | |
| Zinc oxide | 5 | 5 | 5 | 5 | 5 |
| Stearic acid | 1 | 1 | 1 | 1 | 1 |
| FEF carbon (1) | 45 | 45 | 45 | 45 | 45 |
| Plasticizer (2) | 30 | 30 | 30 | 30 | 30 |
| Sulfur | 0.5 | 0.5 | 0.5 | 0.5 | 0.5 |
| TMTD (3) | 1.5 | 1.5 | 1.5 | 1.5 | 1.5 |
| CBS (4) | 1.5 | 1.5 | 1.5 | 1.5 | 1.5 |

Note:

(1) Carbon black Seast SO, mfd. by TOKAI CARBON CO., LTD.

(2) ADEKA CIZER RS 107, mfd. by ASAHI DENKA KOGYO K.K.

(3) Tetramethylthiuram disulfide

(4) N-Cyclohexyl-2-benzothiazyl sulfenamide

The compound Mooney viscosity (M₁₊₄, 100° C.) of the rubber composition was determined according to JIS K6300.

The rubber composition obtained above was press-vulcanized under conditions of 150° C. and 30 minutes to form a uniform vulcanized sheet 2 mm in thickness, which was subjected to determination of tensile properties (tensile strength, elongation) and hardness according to JIS K6251. The fuel oil resistance (fuel oil C (isooctane;/toluene=50/50 by volume)) was determined according to JIS K6258 from the volume change observed after immersion of the specimen in the oil at 40° C. for 48 hours. The low temperature resistance test was conducted according to JIS K6261.

The crack evaluation test at the time of vulcanization forming using a vulcanizer was performed as follows.

Each of the above-mentioned rubber compositions was formed into an unvulcanized rubber hose having an inner diameter of 4.0 mm and an outer diameter of 8.0 mm. Mandrels coated with a releasing agent and having different diameters (diameter: 5.5 mm, 6.0 mm, 6.5 mm), 5 mandrels each for respective diameters, were prepared, and respectively inserted into the unvulcanized rubber hoses (number of test, n=5). Thereafter, each of the unvulcanized rubber hoses having the mandrels inserted therein was steam-vulcanized in a vulcanizer under a pressure of 3.8 kgf/cm² at 150° C. for 30 minutes. The vulcanized rubber hose obtained was taken out and examined for the state of development of cracks at the end and the bend of the rubber hose by visual observation.

The fuel (gasoline) permeability was measured by the aluminum cup method. A specified amount of fuel oil C (isooctane/toluene=50/50 by volume) was placed in an aluminum cup of a 100-ml volume, then the cup was capped with a vulcanized sheet of 2 mm thickness cut out in the form of disc having a diameter of 61 mm, and the cup and the sheet were fixed with a clamp (effective area: 25.5 cm²). The resulting test assembly was allowed to stand in a constant temperature bath at 40° C., and the weight of the assembly was measured every 24 hours. The permeation coefficient was calculated from the maximum decrease in amount of fuel oil with the lapse of time.

The results of the above-mentioned tests are shown in Table 2.

From the comparison of the results of Examples 1 and 2 with the results obtained by using the polyblends of Comparative Examples 1, 2 and 3 shown in Table 2, it is revealed that when the polyblend of a ultra-high NBR having a polymer Mooney viscosity of 97 or 110 with poly(vinyl chloride) of Example 1 or 2 is used, the fuel oil resistance (volume change, permeability) and the low temperature resistance are not deteriorated and no cracks develop at all at the time of vulcanizer forming wherein the mandrel has been inserted and that thus a fuel oil system hose can be obtained which is excellent in resistance to crack development at the time of vulcanization forming thereof and is excellent in fuel oil resistance and low temperature resistance.

Similar results were obtained when confirmation tests were conducted with the same hoses as those for practical use prepared by using the rubber compositions of Example 1 and Comparative Example 3. Thus, when a polyblend of ultra-high NBR having a polymer Mooney viscosity of 97 with poly(vinyl chloride) was used, no cracks were observed at all at the time of vulcanizer forming wherein the mandrel has been inserted, whereas when a polyblend employing ultra-high NBR having a polymer Mooney viscosity of 90 was used, about 3% of defective products due to crack development were observed.

TABLE 2
(Test Results)

| | | Comparative | | | | |
|---|---|---|---|---|---|---|
| | | Example | | | Example | |
| Test Item | | 1 | 2 | 3 | 1 | 2 |
| Compound Mooney viscosity | | 35 | 41 | 44 | 48 | 54 |
| (ML₁₊₄, 100° C.) | | | | | | |
| Crack evaluation test | | | | | | |
| (number of hoses | | | | | | |
| developing cracks) | | | | | | |
| Mandrel diameter | 5.5 mm | 5 | 4 | 2 | 0 | 0 |
| | 6.0 mm | 5 | 5 | 3 | 0 | 0 |
| | 6.5 mm | 5 | 5 | 4 | 0 | 0 |

| | | | | | |
|---|---|---|---|---|---|
| Tensile property | | | | | |
| Tensile strength (MPa) | 18.6 | 18.8 | 18.9 | 19.2 | 19.4 |
| Elongation (%) | 440 | 440 | 440 | 430 | 430 |
| Hardness (Duro A) | 71 | 71 | 71 | 71 | 71 |
| Fuel oil resistance | | | | | |
| Volume change (%) | +13 | +13 | +13 | +13 | +13 |
| Fuel permeability | | | | | |
| Permeation amount | 274 | 272 | 272 | 271 | 268 |
| (mg · mm/m²/day) | | | | | |
| Low temperature | | | | | |
| resistance | | | | | |
| Brittle temperature (° C.) | −28 | −28 | −28 | −28 | −28 |

What is claimed is:

1. A rubber composition comprising a nitrile rubber (a) having a bound unsaturated nitrile content of 43-60% by weight and a polymer Mooney viscosity (ML₁₊₄₁, 100° C.) of 95-140 and a vinyl chloride resin (b).

2. The rubber composition according to claim 1 wherein the ratios of the nitrile rubber (a) and the vinyl chloride resin (b) to the rubber composition are 95-50% by weight and 5-50% by weight, respectively.

3. The rubber composition according to claim 1 wherein the vinyl chloride resin has an average degree of polymerization of 550-2500.

4. The rubber composition according to claim 2 wherein the vinyl chloride resin has an average degree of polymerization of 550-2500.

5. The rubber composition according to claim 1 which further comprises a vulcanizing agent.

6. A fuel system hose comprising the vulcanized product of the rubber composition of claim 5.
